(19) United States
(12) Patent Application Publication
(10) Pub. No.: US 2020/0349466 A1
(43) Pub. Date: Nov. 5, 2020

(54) PROVIDING PERFORMANCE VIEWS ASSOCIATED WITH PERFORMANCE OF A MACHINE LEARNING SYSTEM

(71) Applicant: Microsoft Technology Licensing, LLC, Redmond, WA (US)

(72) Inventors: Scott David HOOGERWERF, Seattle, WA (US); Jacquelyn Marie KRONES, Seattle, WA (US); Benjamin NOAH, Seattle, WA (US); Parham MOHADJER, Redmond, WA (US); Russell Mark EAMES, Redmond, WA (US); Richard Kenneth BARRAZA, Redmond, WA (US); Joshua Jay HINDS, Duvall, WA (US); Semiha Ece KAMAR EDEN, Redmond, WA (US); Besmira NUSHI, Redmond, WA (US); Eric Joel HORVITZ, Kirkland, WA (US)

(21) Appl. No.: 16/403,459

(22) Filed: May 3, 2019

(51) Int. Cl. G06N 20/00

(52) U.S. Cl. CPC G06N 20/00

(57) ABSTRACT

The present disclosure relates to systems, methods and computer readable media for evaluating performance of a machine learning system and providing one or more performance views representative of the determined performance. For example, systems disclosed herein may receive or identify performance information including outputs, accuracy data, and feature data associated with a plurality of test instances. In addition, systems disclosed herein may provide one or more performance views via a graphical user interface including graphical elements (e.g., interactive elements) and indications of accuracy data and other performance data with respect to feature clusters associated with select groupings of test instances from the plurality of test instances. The performance views may include interactive features to enable a user to view and intuitively understand performance of the machine learning system with respect to clustered groupings of test instances that share common characteristics.

### CROSS-REFERENCE TO RELATED APPLICATIONS

### BACKGROUND

Recent years have seen significant improvements and developments in machine learning models that are trained to generate outputs or perform various tasks. Indeed, as machine learning models become more prevalent and complex, the utility of machine learning models continues to increase. For instance, machine learning technology is now being used in applications of transportation, healthcare, criminal justice, education, and productivity. Moreover, machine learning models are often trusted to make high-stakes decisions with significant consequences for individuals and companies.

While machine learning models provide useful tools for processing content and generating a wide variety of outputs, accuracy and reliability of machine learning models continues to be a concern. For example, because machine learning models are often implemented as black boxes in which only inputs and outputs are known, failures or inaccuracies in outputs of machine learning models are difficult to analyze or evaluate. As a result, it is often difficult or impossible for conventional training or testing systems to understand what is causing the machine learning model to fail or generate inaccurate outputs with respect to various inputs. Moreover, conventional training and testing systems are often left to employ brute-force training techniques that are often expensive and inefficient at correcting inaccuracies in machine learning models.

### BRIEF DESCRIPTION OF THE DRAWINGS

FIG. 1 illustrates an example environment of a model evaluation system for evaluating performance of a machine learning system and providing performance views in accordance with one or more embodiments.

FIG. 2 illustrates an example implementation of the model evaluation system for evaluating performance of a machine learning system and generating performance views in accordance with one or more embodiments.

FIG. 3 illustrates an example implementation of the model evaluation system generating a performance report including performance views and associated performance information in accordance with one or more embodiments.

FIGS. 4A-4C illustrate example displays of a variety of performance views in accordance with one or more embodiments.

FIGS. 5A-5D illustrate an example set of interactions with displayed performance views in accordance with one or more embodiments.

FIG. 6 illustrates an example method for displaying performance information of a machine learning system via a performance view in accordance with one or more embodiments.

FIG. 7 illustrates an example method for generating performance information of a machine learning system and providing a performance view in accordance with one or more embodiments.

FIG. 8 illustrates certain components that may be included within a computer system.

### DETAILED DESCRIPTION

The present disclosure is generally related to a model evaluation system for evaluating performance of a machine learning system and generating performance views for displaying performance information associated with accuracy of the machine learning system. In particular, as will be discussed in further detail below, a model evaluation system may receive a test dataset including a set of test instances. The model evaluation system may further receive or otherwise identify label information including attribute or feature information for the test instances and ground truth data associated with expected outputs of the machine learning system with respect to the test instances. The model evaluation system may further generate groupings or clusters of training instances defined by one or more combinations of features associated with members of a set of test instances and/or additional considerations such as evidential information provided by the machine learning system in the course of its analysis of instances or considerations of the details of the application context from where a test case has been sampled. The model evaluation system may further consider identified inconsistencies or inaccuracies between the ground truths and outputs generated by the machine learning system.

Upon identifying performance information associated with performance of a machine learning model, the model evaluation system may further generate performance views to provide via a graphical user interface of a client device. In particular, as will be discussed in further detail below, the model evaluation system may generate and provide performance views including graphical elements and accuracy information associated with one or more feature clusters to provide a feature-based representation of performance of the machine learning system. The model evaluation system may provide a variety of intuitive tools and features that enable a user of a client device (e.g., an app or model developer) to interact with the performance views to gain an understanding of how the machine learning system is performing overall and with respect to specific feature clusters.

The present disclosure includes a number of practical applications that provide benefits and/or solve problems associated with characterizing performance and failures of a machine learning model as well as providing information that enables an individual to understand when and how the machine learning system might be failing or underperforming. For example, by grouping instances from a test dataset into feature clusters based on correlation measures between features and identified output errors of the machine learning system, the model evaluation system can provide tools and functionality to enable an individual to identify groupings of instances based on corresponding features for which the machine learning model is performing well or underperforming. In particular, where certain types of training data are unknowingly underrepresented in training the machine learning system, clustering or otherwise grouping instances based on correlation of features and errors may indicate specific clusters that are associated with a higher concentration of errors or inconsistencies than other feature clusters.

In addition to identifying clusters associated with higher rates of output errors, the model evaluation system may additionally identify and provide an indication of one or more components of the machine learning system that are contributing to the errors. For example, the model evaluation system may identify information associated with confidence values and outputs at respective stages of the machine learning system to determine whether one or more specific models or components of the machine learning system are generating a higher number of erroneous outputs than other stages of the machine learning system. As such, in an example where a machine learning system includes multiple machine learning models (e.g., an object detection model and a ranking model), the model evaluation system may determine that errors are more commonly linked to one or another component of a machine learning system.

As will be discussed in further detail below, the model evaluation system can generate and provide performance views that include interactive elements that allow a user to navigate through performance information and intuitively gain an understanding of how a machine learning system is performing with respect to different types of instances. For example, the model evaluation system may provide different types of performance views that provide various types of performance information across multiple feature clusters (e.g., a global performance view), across instances of a specific feature cluster (e.g., a cluster performance view), and/or with respect to individual test instances (e.g., an instance performance view). Each of these performance views may provide useful and relevant information associated with accuracy of the machine learning system corresponding to different groupings of test instances.

In addition to providing different performance views, the model evaluation system may additional provide interactive tools that enable a user to drill in or out of different performance views to identify which features are most important and/or most correlated with failure of the machine learning system. For example, the model evaluation system may provide graphical elements that enable a user to transition between related performance views. In addition, the model evaluation system may provide selectable elements that enable a user to add or remove select portions of the performance data from displayed results corresponding to different feature labels. Moreover, the model evaluation system may provide additional tools such as indications or rankings of feature importance to guide a user in how to navigate through the performance information.

By providing performance views in accordance with one or more embodiments described herein, the model evaluation system can significantly improve the efficiency with which an individual can view and interact with performance information. For example, by providing selectable graphical elements, the model evaluation system enables a user to toggle between visualizations of performance associated with different feature combinations. Moreover, in contrast to conventional systems that may simply include a table of instances and associated performance data, the displayed graphical elements and indicators of performance enable a user to identify and select combinations of features having a joint correlation to output failures and other variables that significantly improve efficiency of development systems generally as well as enabling a user to improve upon the operation of a training system by allowing the user to selectively identify features to use in selectively training the machine learning system.

Moreover, by providing performance views in accordance with one or more embodiments described herein, the model evaluation system can improve system performance by reducing the quantity of performance information provided to a user. For example, where a machine learning system is performing above a threshold level with respect to certain feature clusters, the model evaluation system may generate performance views that exclude performance information that is not important or otherwise not interesting to a user. Indeed, where a user is more interested in instances that are resulting in failed outputs, the model evaluation system may more efficiently provide results that focus on these types of instances rather than providing massive quantities of data that cannot be displayed efficiently or that involves using significant processing resources of a client device and/or server.

In addition to providing a display of performance information and enabling a user to easily navigate through the performance information, the model evaluation system can utilize the clustering information and select performance information to more efficiently and effectively refine the machine learning system in a variety of ways. For example, by identifying important feature clusters or feature clusters more commonly associated with output failures, the model evaluation system may indicate one or more combinations of features to use in selectively identifying additional training data for refining one or more components (e.g., discrete machine learning models) of a machine learning system. Moreover, the model evaluation system may provide interactive features that enable a user to identify components of a machine learning system and/or combinations of one or more feature labels to use in selectively identifying additional training data for refining a machine learning system.

As illustrated in the foregoing discussion, the present disclosure utilizes a variety of terms to describe features and advantages of the model evaluation system. Additional detail is now provided regarding the meaning of such terms. For example, as used herein, a “machine learning model” refers to a computer algorithm or model (e.g., a classification model, a regression model, a language model, an object detection model) that can be tuned (e.g., trained) based on training input to approximate unknown functions. For example, a machine learning model may refer to a neural network (e.g., a convolutional neural network (CNN), deep neural network (DNN), recurrent neural network (RNN)), or other machine learning algorithm or architecture that learns and approximates complex functions and generates outputs based on a plurality of inputs provided to the machine learning model. As used herein, a “machine learning system” may refer to one or multiple machine learning models that cooperatively generate one or more outputs based on corresponding inputs. For example, a machine learning system may refer to any system architecture having multiple discrete machine learning components that consider different kinds of information or inputs.

As used herein, an “instance” refers to an input object that may be provided as an input to a machine learning system to use in generating an output. For example, an instance may refer to a digital image, a digital video, a digital audio file, or any other media content item. An instance may further include other digital objects including text, identified objects, or other types of data that may be analyzed using one or more algorithms. In one or more embodiments described herein, an instance is a “training instance,” which refers to an instance from a collection of training instances used in training a machine learning system. An instance may further refer to a “test instance,” which refers to an instance from a test dataset used in connection with evaluating performance of a machine learning system. Moreover, an “input instance” may refer to any instance used in implementing the machine learning system for its intended purpose. As used herein, a “test dataset” may refer to a collection of test instances and a “training dataset” may refer to a collection of training instances.

As used herein, “test data” may refer to any information associated with a test dataset or respective test instance from the test dataset. For example, in one or more embodiments described herein, test data may refer to a set of test instances and corresponding label information. As used herein, “label information” refers to labels including any information associated with respective instances. For example, label information may include identified features (e.g., feature labels) associated with one or more features of a test instance. This may include features associated with content from test instances. By way of example, where a test instance refers to a digital image, identified features may refer to identified objects within the digital image and/or a count of one or more identified objects within the digital image. As a further example, where a test instance refers to a face or individual (e.g., an image of a face or individual), identified features or feature labels may refer to characteristics about the content such as demographic identifiers (e.g., race, skin color, hat, glasses, smile, makeup) descriptive of the test instance. Other examples include characteristics of the instance such as a measure of brightness, quality of an image, or other descriptor of the instance.

In addition to characteristics of the test instances, features (e.g., feature data) may refer to evidential information provided by a machine learning system during execution of a test. For example, feature data may include information that comes from a model or machine learning system during execution of a test. This may include confidence scores, runtime latency, etc. Using this data, systems described herein can describe errors with respect to system evidence rather than just content of an input. As an example, a performance view may indicate instances of system failure or rates of failure for identified feature clusters when a confidence of one or more modules is less than a threshold.

As a further example, features (e.g., feature data) may refer to information that comes from the contest of where a test instance comes from. For example, where a machine learning system is trained to perform face identification, feature data for a test instance may include information about whether a person is alone in a photo or are surrounded by other people or objects (e.g., and how many). In this way, performance views may indicate failure conditions that occur under different contexts of test instances.

In addition to identified features or feature labels, the “label information” may further include ground truth data associated with a corresponding machine learning system (or machine learning models). As used herein, “ground truth data” refers to a correct or expected outcome (e.g., an output) upon providing a test instance as an input to a machine learning system. Ground truth data may further indicate a confidence value or other metric associated with the expected outcome. For example, where a machine learning system is trained to identify whether an image of a person should be classified as a man or a woman, the ground truth data may simply indicate that the image includes a photo of a man or woman. The ground truth data may further indicate a measure of confidence (or other metric) that the classification is correct. This ground truth data may be obtained upon confirmation from one or a plurality of individuals when presented the image (e.g., at an earlier time). As will be discussed in further detail below, this ground truth data may be compared to outputs from a machine learning system to generate error labels as part of a process for evaluating performance of the machine learning system.

In one or more embodiments described herein, a machine learning system may generate an output based on an input instance in accordance with training of the machine learning system. As used herein, an “output” or “outcome” of a machine learning system refers to any type of output from a machine learning model based on training of the machine learning model to generate a specific type of output or outcome. For example, an output may refer to a classification of an image, video, or other media content item (or any type of instance) such as whether a face is detected, an identification of an individual, an identification of an object, a caption or description of the instance, or any other classification of a test instance corresponding to a purpose of the machine learning system. Other outputs may include output images, decoded values, or any other data generated based on one or more algorithms employed by a machine learning system to analyze or process an instance.

As used herein, a “failed output” or “output failure” may refer to an output from a machine learning system determined to be inaccurate or inconsistent with a corresponding ground truth. For example, where a machine learning system is trained to generate a simple output, such as an identification of an object, a count of objects, or a classification of a face as male or female, determining a failed output may be as simple as identifying that an output does not match a corresponding ground truth from the test data. In one or more embodiments, the machine learning system may implement other more complex techniques and methodologies for comparing an output to corresponding ground truth data to determine whether an output is a failed output (e.g., inconsistent with the ground truth data) or correct output. In one or more embodiments, a failure label may be added or otherwise associated with an instance based on a determination of a failed output.

As used herein, “performance information” may include any information associated with accuracy of a machine learning system with respect to outputs of the machine learning system and corresponding ground truth data. For example, performance information may include outputs associated with respective test instances. Performance information may further include accuracy data including identified errors (e.g., error labels) based on inconsistencies between outputs and ground truth data. The performance information may additionally include measurements of correlation between failed outputs and corresponding features or feature labels. For example, performance information may include calculated rates of failure for specific combinations of features, rankings of importance for different feature clusters, and/or identified failures with respect to outputs of sub-components (e.g., machine learning models) of a machine learning system.

As used herein, a “performance view” may refer to an interpretable error prediction model including or otherwise facilitating a visualization of data associated with performance of a machine learning system. For example, a performance view may include indicators of performance such as a metric of correlation between failed outputs and test instances associated with one or more feature labels. A performance view may further include a visualization of performance across multiple feature clusters (e.g., a global performance view). A performance view may further include a visualization of performance for test instances for one or multiple feature clusters associated with combinations of one or more features. Moreover, a performance view may further include a visualization of performance of the machine learning model with respect to individual test instances.

In each of the examples of performance views, performance information may be provided that includes indications of performance of the machine learning system with respect to a variety of feature clusters corresponding to a variety of different types of features. For example, as mentioned above, performance views may indicate performance of the machine learning system for clusters of test instances that share one or more common features of a variety of types including test instances that share common content or characteristics, test instances associated with similar evidential information provided by the machine learning system during execution of the test, and/or test instances associated with similar contextual information from where the test instance has been sampled. Additional detail in connection with example performance views of different types is discussed below in connection with multiple figures.

While one or more embodiments described herein refer to specific types of machine learning systems (e.g., classification systems, capturing systems) that employ specific types of machine learning models (e.g., neural networks, language models), it will be understood that features and functionalities described herein may be applied to a variety of machine learning systems. Moreover, while one or more embodiments described herein refer to specific types of test instances (e.g., images, videos) having limited input domains, features and functionalities described in connection with these examples may similarly apply to other types of instances for various applications having a wide variety of input domains.

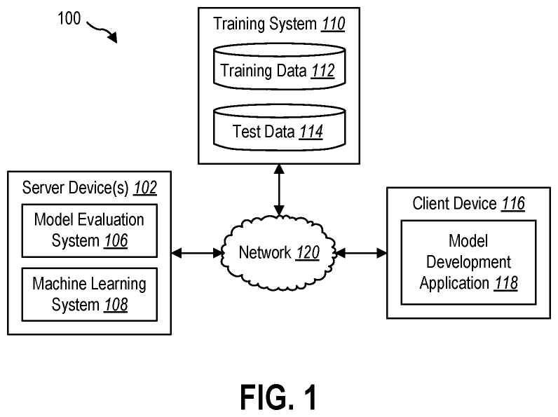

Additional detail will now be provided regarding a model evaluation system in relation to illustrative figures portraying example implementations. For example, FIG. 1 illustrates an example environment 100 in which performance of a machine learning system may be evaluated in accordance with one or more embodiments described herein. As shown in FIG. 1, the environment 100 includes one or more server device(s) 102 including a model evaluation system 106 and one or more machine learning systems 108. The environment 100 further includes a training system 110 having access to training data 112 and test data 114 thereon. The environment 100 also includes a client device 116 having a model development application 118 implemented thereon.

As shown in FIG. 1, the server device(s) 102, training system 110, and client device 116 may communicate with each other directly or indirectly through a network 120. The network 120 may include one or multiple networks and may use one or more communication platforms or technologies suitable for transmitting data. The network 120 may refer to any data link that enables the transport of electronic data between devices and/or modules of the environment 100. The network 120 may refer to a hardwired network, a wireless network, or a combination of a hardwired and a wireless network. In one or more embodiments, the network 120 includes the Internet.

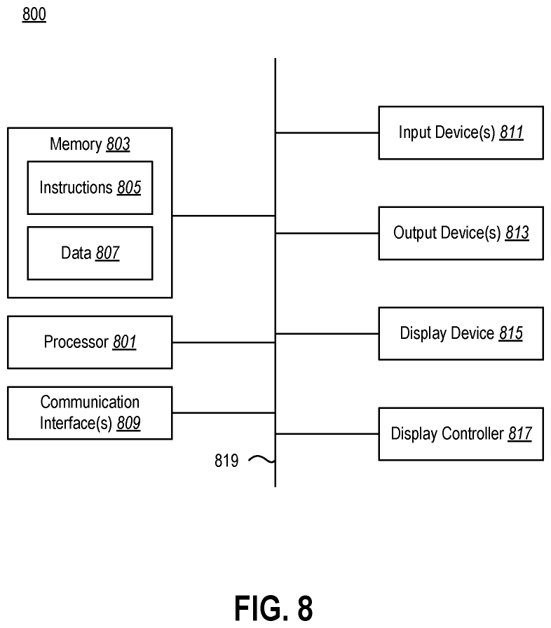

The client device 116 may refer to various types of computing devices. For example, the client device 116 may include a mobile device such as a mobile telephone, a smartphone, a personal digital assistant (PDA), a tablet, or a laptop. Additionally, or alternatively, the client device 116 may include a non-mobile device such as a desktop computer, server device, or other non-portable device. The server device(s) 102 may similarly refer to various types of computing devices. Moreover, the training system 110 may be implemented on one of a variety of computing devices. Each of the devices of the environment 100 may include features and functionality described below in connection with FIG. 8.

As mentioned above, the machine learning system 108 may refer to any type of machine learning system trained to generate one or more outputs based on one or more input instances. For example, the machine learning system 108 may include one or more machine learning models trained to generate an output based on training data 112 including any number of sampled training instances and corresponding truth data (e.g., ground truth data). The machine learning system 108 may be trained locally on the server device(s) 102 or may be trained remotely (e.g., on the training system 110) and provided, as trained, to the server device 102 for further testing or implementing. Moreover, while FIG. 1 illustrates an example in which the training system 110 is implemented on a separate device or system of devices as the model evaluation system 106, the training system 110 may be implemented (in part or as a whole) on the server device(s) 102 in connection with or as an integrated sub-system of the model evaluation system 106.

As will be discussed in further detail below, the model evaluation system 106 may evaluate performance of the machine learning system 108 and provide one or more performance views to the client device 116 for display to a user of the client device 116. In one or more embodiments, the model development application 118 refers to a program running on the client device 116 associated with the model evaluation system 106 and capable of rendering, displaying, or otherwise presenting the performance views via a graphical user interface of the client device 116. In one or more embodiments, the model development application 118 refers to a program installed on the client device 116 associated with the model evaluation system 106. In one or more embodiments, the model development application 118 refers to a web application through which the client device 116 provides access to features and tools described herein in connection with the model evaluation system 106.

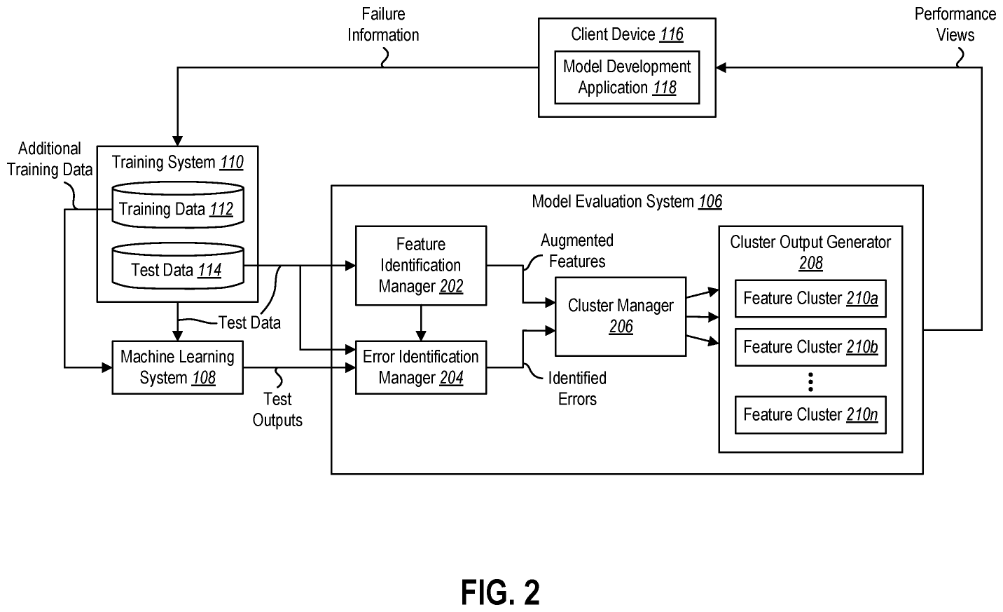

Additional detail will now be given in connection with an example implementation in which the model evaluation system 106 receives test data and evaluates performance of a machine learning system 108 to generate and provide performance views to the client device 116. For example, FIG. 2 illustrates an example framework in which the model evaluation system 106 characterizes performance of the machine learning system 108 with respect to a plurality of feature clusters. As shown in FIG. 2, the model evaluation system 106 may include a feature identification manager 202, an error identification manager 204, and a cluster manager 206. The model evaluation system 106 may additionally include an output generator 208 that generates performance views based on a plurality of feature clusters 210a-n identified or otherwise generated by the model evaluation system 106. Further detail in connection with each of these components 202-208 is provided below.

As shown in FIG. 2, the machine learning system 108 may receive test data 114 from the training system 110 that includes a plurality of test instances (e.g., a training dataset) to provide as inputs to the machine learning system 108. The machine learning system 108 may generate test outputs from the test instances based on training of the machine learning system (e.g., based on sampled training data 112). The test outputs may include a variety of different outputs in accordance with a programmed purpose or component architecture of the machine learning system 108. In one or more examples described herein, the machine learning system 108 refers to a gender classification system trained to output whether a face or profile image (e.g., an image including a face or profile) should be classified as male or female based on the training data 112.

The training system 110 may further provide test data 114 to the model evaluation system 106. In particular, the training system 110 may provide test data 114 including training instances and associated data to a feature identification manager 202. The feature identification manager 202 may identify feature labels based on the test data 114. For example, the feature identification manager 202 may identify features based on label information included within the test data 114 based on previously identified features associated with respective test instances (e.g., feature labels previously included within the test data 114). As used herein, the “features” or “feature labels” may include indications of characteristics of content (e.g., visual features, quality features such as image quality or image brightness, detected objects and/or counts of detected objects) from the test instances.

In addition to or as an alternative to identifying feature labels associated with test instances within the test data 114, the feature identification manager 202 may further augment the test data 114 to include one or more feature labels not previously included within the test data 114. For example, the feature identification manager 202 may augment the test data 114 to include one or more additional feature labels by evaluating the test instances and associated data to identify any number of features associated with corresponding test instances. In one or more implementations, the feature identification manager 202 may augment the feature labels by applying an augmented feature model including one or more machine learning models trained to identify any number of features (e.g., from a predetermined number of known features to the machine learning model) associated with the test instances. Upon identifying or otherwise augmenting the feature data associated with the test instances, the feature identification manager 202 may provide augmented features (e.g., identified and/or created feature labels) to the cluster manager 206 for further processing.

As further shown in FIG. 2, an error identification manager 204 may receive test outputs from the machine learning system 108 including outputs generated by the machine learning system 108 based on respective test instances from the test dataset. In addition to the test outputs, the error identification manager 204 may receive test data 114 from the training system 110 that includes label information indicating ground truths. The ground truths may include expected or “correct” outputs of the machine learning system 108 for the test instances.

In one or more embodiments, the error identification manager 204 may compare the test outputs to the ground truth data to identify outputs that are erroneous or inaccurate with respect to corresponding ground truths. In one or more embodiments, the error identification manager 204 generates error labels and associates the error labels with corresponding test instances in which the test output does not match or is otherwise inaccurate with respect to the ground truth data. As shown in FIG. 2, the error identification manager 204 may provide the identified errors (e.g., error labels) and associated label information (e.g., feature labels) to the cluster manager 206 for further processing.

The cluster manager 206 may generate feature clusters based on a combination of the augmented features provided by the feature identification manager 202 and the identified errors (e.g., error labels) provided by the error identification manager 204. In particular, the cluster manager 206 may determine correlations between features (e.g., individual features, combinations of multiple features) and the error labels. For example, the cluster manager 206 may identify correlation metrics associated with any number of features and the error labels. The correlation metrics may indicate a strength of correlation between test instances having certain combinations of features (e.g., associated combinations of feature labels) and a number or percentage of output errors for outputs based on those test instances associated with the combinations of features.

The cluster manager 206 can generate feature clusters 210a-n associated with combinations of one or more features. For example, the cluster manager 206 can generate a first feature cluster 210a based on an identified combination of features having a higher correlation to failed outputs than other combinations of features. The cluster manager 206 may further generate a second feature cluster 210b based on an identified combination of features having a second highest correlation to failed outputs than other combinations of features. As shown in FIG. 2, the cluster manager 206 may generate any number of feature clusters 210a-n based on combinations of feature labels. In one or more embodiments, the listing of feature clusters 210a-n is representative of a ranking of feature combinations having a high correlation between corresponding test instances and output failures relative to other combinations of features.

The feature clusters may satisfy one or more constraints or parameters in accordance with criteria used by the cluster manager 206 when generating the feature clusters. For example, the cluster manager 206 may generate a predetermined number of feature clusters to avoid generating an unhelpful number of clusters (e.g., too many distinct clusters) or clusters that are too small to provide meaningful information. The cluster manager 206 may further generate feature clusters having a minimum number of test instances to ensure that each cluster provides a meaningful number of test instances.

In one or more embodiments, the feature clusters 210a-n include some overlap between respective groupings of test instances. For example, one or more test instances associated with the first feature cluster 210a may similarly be grouped within the second feature cluster 210b. Alternatively, in one or more embodiments, the feature clusters 210a-n include discrete and non-overlapping groupings of test instances in which test instance do not overlap between feature clusters. Accordingly, in some embodiments, the first feature cluster 210a includes no common test instances as the second feature cluster 210b.

As shown in FIG. 2, the cluster manager 206 may provide the feature clusters (or an indication of labeling information corresponding to the identified feature clusters) to the cluster output generator 208 for generating performance views including performance information for the respective feature clusters 210a-n. For example, the cluster output generator 208 may generate a performance report including performance information and performance views associated with performance of the machine learning system 108 with respect to the identified feature clusters. In one or more embodiments, the performance information includes performance information with respect to individual components or models that make up the machine learning system 108.

As will be discussed in further detail below, the cluster output generator 208 may generate a variety of performance views including a global performance view including a visualization of performance (e.g., accuracy) of the machine learning system 108 across multiple feature clusters. The cluster output generator 208 may further generate one or more cluster performance views including a visualization of performance of the machine learning system 108 for an identified feature cluster. The cluster output generator 208 may further generate one or more instance performance views including a visualization of performance of the machine learning system 108 for one or more test instances. Further detail in connection with the performance views will be discussed below.

As shown in FIG. 2, the cluster output generator 208 may provide the performance views and associated performance information to the client device 116. The model development application 118 on the client device 116 may provide a display of one or more performance views via a graphical user interface on the client device 116. For example, as will be discussed further below, the model development application 118 may provide an interactive performance view that enables a user of the client device 116 to interact with graphical elements to modify a display of the performance view(s) and view performance data associated with performance of the machine learning system 108 with respect to the feature clusters and/or for specific test instances within identified feature clusters.

As further shown in FIG. 2, the client device 116 may provide failure information to the training system 110 to guide the training system 110 in further refining the machine learning system 108. For example, the client device 116 may provide an indication of one or more feature clusters associated with low performance of the machine learning system 108. In one or more embodiments, the client device 116 provides the failure information based on interactions with the performance views by a user of the client device 116. Alternatively, in one or more embodiments, the client device 116 provides failure information automatically (e.g., without receiving a command to send the failure information from a user of the client device 116).

As mentioned above in connection with FIG. 1, the model development application 118 may refer to a software application installed or otherwise implemented locally on the client device 116. For example, in one or more embodiments, the model development application 118 refers to an application that receives a performance report including performance information from the model evaluation system 106 and renders, generates, or otherwise provides the performance views via the graphical user interface of the client device 116. Alternatively, in one or more embodiments, the model development application 118 refers to a web application or other application hosted by or provided via the model evaluation system 106 that provides a display via the graphical user interface of the client device as generated or provided by the model evaluation system 106. It will be appreciated that one or more embodiments described herein in connection with the model development application 118 providing a performance view or otherwise providing elements via the graphical user interface of the client device 116 may be similarly performance by the model evaluation system 106 on the server device(s) 102, as shown in FIG. 1.

Upon receiving the failure information, the training system 110 may further provide additional training data 112 to the machine learning system 108 to fine-tune or otherwise refine one or more machine learning models of the machine learning system 108. In particular, the training system 110 may selectively sample or identify training data 112 (e.g., a subset of training data from a larger collection of training data) corresponding to one or more identified feature clusters (or select features labels) associated with high error rates or otherwise low performance of the machine learning system 108 and provide relevant and helpful training data 112 to the machine learning system 108 to enable the machine learning system 108 to generate more accurate outputs for input instances having similar sets of features. Moreover, the training system 110 can selectively sample training data associated with poor performance of the machine learning system 108 without providing unnecessary or unhelpful training data 112 for which the machine learning system 108 is already adequately trained to process.

Upon refining the machine learning system 108, the model evaluation system 106 may similarly collect test data and additional outputs from the refined machine learning system 108 to further evaluate performance of the machine learning system 108 and generate performance views including updated performance statistics. Indeed, the model evaluation system 106 and training system 110 may iteratively generate performance information, provide updated performance views, collect additional failure information, and further refine the machine learning system 108 any number of times until the machine learning system 108 is performing at a satisfactory or threshold level of accuracy generally and/or across each of the feature clusters. In one or more embodiments, the machine learning system 108 is iteratively refined based on performance information (and updated performance information) associated with respective features, even where a user does not expressly indicate one or more feature combinations associated with higher rates of output failures. For example, with or without receiving an express indication of feature data from a client device 116, the model evaluation system 106 may provide identified feature data associated with one or more feature clusters that are associated with threshold failure rates of the machine learning system 108.

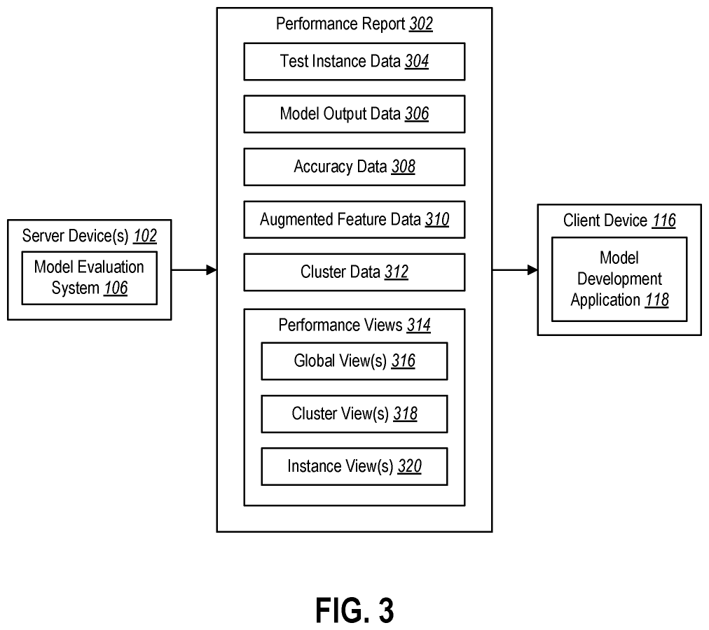

As mentioned above, the model evaluation system 106 can provide (e.g., cause the server device(s) 102 to provide) performance information to the client device 116. FIG. 3 illustrates an example in which the model evaluation system 106 provides a performance report 302 including performance information associated with performance of the machine learning system 108 with respect to a set of test instances. As used herein, a performance report may refer to a digital file, a web document (e.g., a hypertext markup language (HTML) document), or any structure or protocol for providing performance information and performance views to a client device.

As shown in FIG. 3, the performance information may include test instance data 304 including any information associated with the test instances. The test instance data 304 may include the test dataset including the specific test instances (e.g., a set of test images provided as inputs to the machine learning system 108). The test instance data 304 may further include ground truth data indicating expected outputs of the machine learning system 108 for the corresponding test instances.

As further shown in FIG. 3, the performance information may include model output data 306 including any information associated with a set of outputs from the machine learning system 108. The model output data 306 may include test outputs generated by the machine learning system 108. The model output data 306 may further include confidence scores or various metrics indicating a level of confidence as determined by the machine learning system 108 that the output is correct. In one or more embodiments, the model output data 306 includes multiple outputs from multiple stages of the machine learning system 108. For example, where the machine learning system 108 includes multiple machine learning models or sub-components that generate individual outputs, the model output data 306 may include each stage output (and associated output data) from each machine learning model that are collectively used in generating the test output.

As further shown in FIG. 3, the performance information may include accuracy data 308 including any information associated with accuracy of outputs generated by the machine learning system 108 and corresponding ground truth data. The accuracy data 308 may include identified failures (e.g., failure labels) tagged with or otherwise associated with corresponding test instances. The accuracy data may further include accuracy metrics (e.g., rates of error) with respect to specific features, combinations of features, or specific components of the machine learning system 108. The accuracy data may include metrics such as error amounts, cluster failures, or any determined metric associated with performance of the machine learning system 108 in generating the outputs for the test dataset.

The performance information may additionally include the augmented feature data 310 including any number of feature labels associated with the test instances. The feature data 310 may include individual features in addition to combinations of multiple features. The augmented feature data 310 may include feature labels previously associated with test instances (e.g., prior to the model evaluation system 106 receiving the test data 114). Alternatively, the augmented feature data 310 may include additional features identified by the feature identification manager 202 based on further evaluation of characteristics of the test instances.

As further shown, the performance information may include cluster data 312 including identified features or combinations of features corresponding to subsets of test instances. The cluster data 312 may refer generally to any subset of test instances corresponding to any number of combinations of feature labels. In one or more embodiments described herein, the cluster data 312 refers to information associated with an identified number of feature clusters determined to correlate to failure outputs from the machine learning system 108. For example, as discussed above, the cluster manager 206 may identify any number or a predetermined number of feature clusters based on failure rates for test instances having associated combinations of feature labels.

Moreover, in one or more embodiments, the cluster manager 206 may implement or otherwise utilize a model or system trained to identify feature clusters based on a variety of factors to identify important combinations of features that have higher correlation to failed outputs than other combinations of features. In one or more embodiments, the cluster data 312 includes a measure of correlation or importance between the identified feature clusters and output failures. For example, the cluster data 312 may include a ranking of importance for identified feature clusters.

As further illustrated in FIG. 3, the performance report 302 may include performance views 314. As mentioned above, the performance views 314 may include visualizations of performance (e.g., visualizations of the accuracy data) of the machine learning system 108 with respect to generating outputs that are accurate or inaccurate with respect to corresponding ground truth data. In one or more embodiments, the performance views 314 are provided for display from the model evaluation system 106. Alternatively, in one or more embodiments, the performance information be provided to the client device 116 where the model development application 118 generates and displays the performance views 314 based on the provided performance information.

The performance views 314 may include global performance views 316 including a visualization of performance of the machine learning system 108 across any number of identified feature clusters. In addition, the performance views 314 may include cluster views 318 including a visualization of performance of the machine learning system 108 for any number of feature clusters. The performance views 314 may additionally include instance views 320 including a visualization of performance of the machine learning system 108 for individual test instances provided as inputs to the machine learning system 108. Examples of each of these performance views 314 are discussed in further detail below.

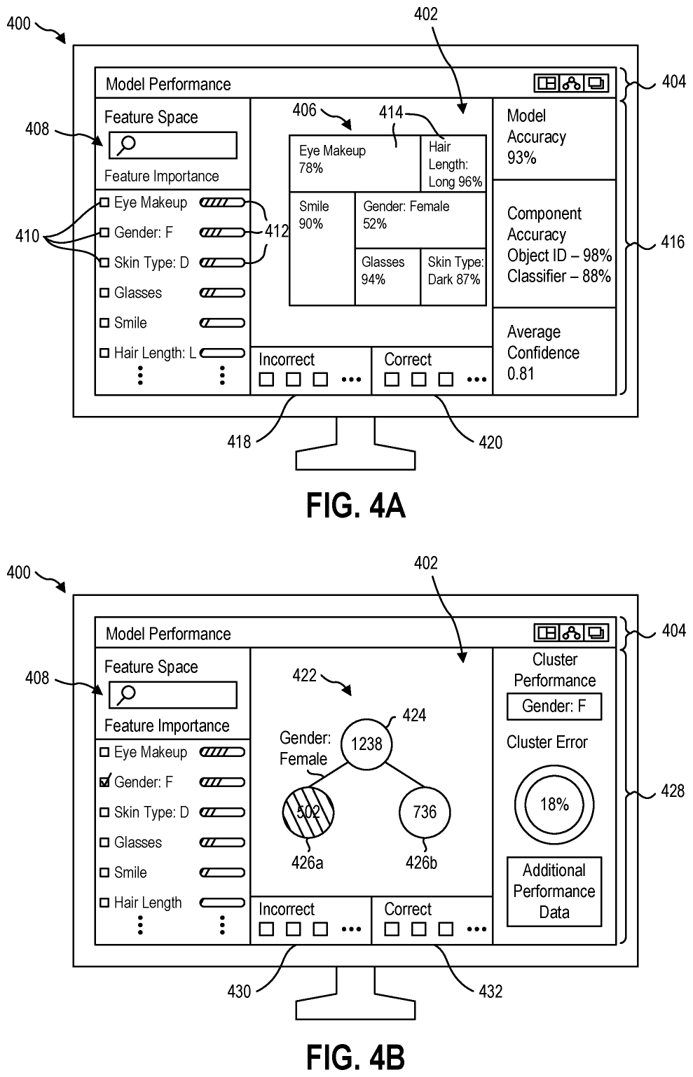

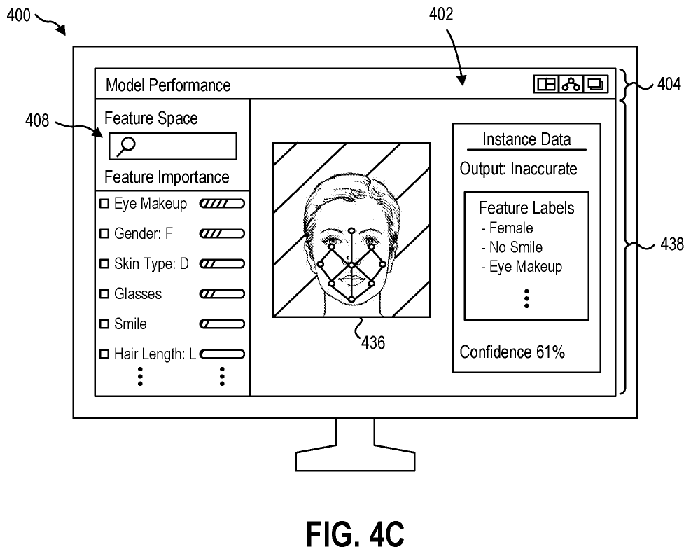

FIGS. 4A-4C illustrate example displays of performance views provided via a graphical user interface of a client device. In particular, each of FIGS. 4A-4C illustrate different types of performance views provided via a graphical user interface 402 of a client device 400. The client device 400 may be an example of the client device 116 having the model development application 118 thereon discussed above in connection with FIGS. 1-3.

In the examples shown in FIGS. 4A-4C, the performance views include displayed performance information associated with a machine learning system trained to generate a classification of whether a face or profile image (e.g., an image including a face or individual profile) should be classified as a man or a woman. This example is provided to illustrate features and functionality of the model evaluation system 106 and/or model development application 118 generally. As such, it will be understood that features discussed in connection with specific outputs, classifications, and performance data may apply to other types of machine learning models trained to receive different types of inputs as well as generate different types of outputs.

For example, while examples discussed herein may relate to a binary output of male or female, similar principles may apply to a machine learning model trained to generate other types of outputs having a larger domain range and variety of feature labels. Indeed, features and functionalities discussed in connection with the illustrated examples may apply to any of the above types of machine learning systems indicated above. Moreover, while one or more embodiments described herein relate to performance views associated with accuracy of test outputs from a machine learning system, the model development application 118 may similarly provide multiple performance views for individual components (e.g., models or stages) that make up a multi-component machine learning system.

In each of the example performance views, the graphical user interface 402 may include a graphical element including multi-view indicator 404 that enables a user of the client device 400 to switch between different types of performance views. For example, the model development application 118 may transition between displaying each of the performance views illustrated in respective FIGS. 4A-4C in response to detecting a selection of the multi-view indicator 404 displayed via a toolbar of the individual performance views.

As further shown, some or all of the different types of performance views may include a feature space 408 that includes a number of graphical elements that enable a user of the client device 400 to interact with the performance view(s) and modify the performance information displayed therein. For example, the feature space 408 may include a list of feature icons 410 corresponding to feature labels or combinations of feature labels such as “Eye Makeup,” “Gender: Female,” “Skin Type: Dark,” “Glasses,” “Smile,” “Hair Length: Long,” and other features. Each of these feature icons 410 may refer to feature labels from the test data and/or augmented features identified as a supplement or augmentation to the test data.

In addition to the feature icons 410, the model development application 118 may further provide importance indicators 412 associated with performance of the machine learning system 108 associated with features corresponding to the feature icons 410. For example, as shown in FIG. 4A, the listing of feature icons 410 may include a ranked list in which each feature icon is ordered based on measures of correlation between feature clusters associated with the indicated features and identified output errors from the performance data.

Indeed, the importance indicators 412 may include a visualization or other indication of a strength of correlation between the feature clusters and output errors. For example, in the feature space 408 shown in FIG. 4A, a first feature icon corresponding to a feature of eye makeup (e.g., test instances in which eye makeup has been detected or otherwise identified) may correspond to an importance indicator that indicates the eye makeup feature label as the most important feature from a plurality of identified features based on a high correlation between test instances in which eye makeup has been identified and output failures. The feature icons 410 may similarly descend in order of importance as indicated by the importance indicators 412.

The performance view may include selectable graphical elements that facilitate modification of the displayed performance information. For example, in addition to the selectable icons 410, a multi-cluster performance graphic 406 is shown that includes cluster performance indicators 414. In the illustrated example, each of the cluster performance indicators 414 may show a percentage (or other performance indicator or metric) that the machine learning system 108 is accurate with respect to outputs from test instances of the respective feature clusters. For example, a first performance indicator associated with a feature of eye makeup may indicate a 78% rate of accuracy for test instances in which an eye makeup feature label has been identified. Along similar lines, another performance indicator for a feature of a smile may indicate a 90% rate of accuracy for test instances in which a smile label has been identified. The multi-cluster performance graphic 406 may include any number of cluster performance indicators 414 associated with different feature combinations.

In one or more embodiments, the multi-cluster performance graphic 406 includes cluster performance indicators 414 for each of the feature combinations shown in the list of feature icons 410 displayed or selected from the feature space 408. For example, the multi-cluster performance graphic 406 may include a predetermined number of cluster performance indicators 414 corresponding to features that have been identified as the most important. Alternatively, in one or more embodiments, the multi-cluster performance graphic 406 includes a number of cluster performance indicators 414 corresponding to feature icons 410 that have been selected or deselected by a user of the client device 400. For example, a user may modify the multi-cluster performance graphic 406 by selecting or deselecting one or more of the feature icons 410 and causing one or more of the cluster performance indicators 414 to be removed and/or replaced by a different performance indicator corresponding to a different combination of features. Moreover, while the multi-cluster performance graphic 406 is illustrated using a tile-view (e.g., blocks or tiles organized in a square, rectangle, or grid), the multi-cluster performance graphic 406 may be illustrated using a pie-chart, bar-chart, or other visualization tool to represent performance of the machine learning system 108 across the multiple clusters.

In addition to the multi-cluster performance graphic 406, the global performance view may include additional global performance data 416 displayed within the graphical user interface 402. For example, as shown in FIG. 4A, the additional global performance data 416 may include an indication of model accuracy (e.g., 93% of a set of outputs are determined to be accurate with respect to ground truth data). The global performance data 416 may further include indications of component accuracy. For example, where the machine learning system includes an object identification model (e.g., a machine learning model trained to identify objects) and a classification model trained to generate a classification of an image or other instance, the global performance data 416 may include metrics of accuracy for each of the individual models (e.g., 98% for an object identification model and 88% for a classifier model). As a further example, the global performance data 416 may include an average confidence value (or any other performance metric) determined for the outputs of the machine learning system 108.

The global performance view may further include one or more instance icons grouped within incorrect and correct categories. For example, the model development application 118 may provide a first grouping of icons 418 including thumbnail images or other graphical elements that a user may select to view individual test instances that correspond to error outputs from the machine learning system 108. The model development application 118 may further provide a second grouping of icons 420 including thumbnail images or other graphical elements that a user may select to view individual test instances that correspond to accurate outputs from the machine learning system 108.

Referring now to FIG. 4B, the model development application 118 may provide a cluster performance view that includes graphical elements and performance indicators indicating performance of the machine learning system 108 with respect to test instances associated with a specific (e.g., a selected) feature cluster. For example, in response to a user selection of a female gender icon from the list of feature icons 410 and/or in response to detecting a selection of a corresponding icon from the multi-view indicator 404, the model development application 118 may provide a multi-branch display 422 including indicators of performance with respect to outputs associated with a selected feature cluster (e.g., outputs for test instances from a female gender feature cluster).

As shown in FIG. 4B, the multi-branch display 422 may have a first level including root node 424 associated with the test dataset, which may include an indicator of performance for the entire test dataset and/or a total number of test instances included within the test dataset. The multi-branch display 422 may further include a second level below the root node 424 that includes a first feature node 426a and a second feature node 426b. The first feature node 426a may be representative of test instances from the test dataset having an associated female feature label. Further, the second feature node 426b may represent test instances from the test dataset having a different feature label (e.g., a male feature label) or with which a female feature label is not associated.

While FIGS. 4B illustrates an example in which the first level of the multi-branch display 422 includes two nodes corresponding to two different feature labels (or other binary feature labels), it will be appreciated that the cluster performance view may include multi-branch displays including any number of branches. As an example, where a feature of “hair length” may include characterizations indicated by feature labels such as “bald,” “short,” “medium,” “long,” “very long,” etc., the multi-branch display may include any number of nodes corresponding to related features or combinations of features representative of subsets of test instances of the test dataset represented by the root node. Moreover, where one or more of the feature labels may be combined (e.g., bald and short hair lengths or long and very long hair lengths), the multi-branch display may be modified to reflect any number of feature combinations (e.g., based on a setting limiting a number of branches and/or based on user input indicating a preferred number of branches).

As further shown, the cluster performance view may include displayed performance information 428 associated with a selected feature cluster. For example, based on a selection of the first node 426a from the first level corresponding to a feature label of “gender: female,” the model development application 118 may provide a display of performance information with respect to test instances from the selected feature cluster including an indicated number (e.g., 502) test instances. As shown in FIG. 4B, examples of the displayed performance information 428 may include an indication of the gender label and/or a displayed graphic of an error rate for the cluster (e.g., 18%). The displayed performance information 428 may further include an additional performance data icon that, when selected, causes additional performance information corresponding to the feature cluster to be provided via the cluster performance view.

This error rate may refer to different types of error metrics. For example, this may refer to a cluster error or node error indicating a rate of failed outputs for test instances having the associated combination of features. Alternatively, this may refer to a global error indicating an error rate for the feature cluster as it relates to the test dataset. To illustrate, where a test dataset includes 1000 test instances corresponding to 100 incorrect outputs and 900 correct outputs (corresponding to a 90% accuracy rate across all test instance) and a node cluster indicates a subset of 60 instances including 30 incorrect outputs and 30 correct outputs, a cluster error or node error may equal 50% (corresponding to an error rate of instances within the feature cluster). Alternatively, a global error may be determined as 30 errors from the feature cluster divided by a sum of total errors and the number of errors from the feature cluster (e.g., 100+30), resulting in a global error metric of 30/130 or approximately 23%.

Similar to the global performance view shown in FIG. 4A, the cluster performance view may further include instance icons grouped within incorrect and correct categories and corresponding to test instances that share features of the selected feature cluster (e.g., the selected node). For example, the model development application 118 may provide a first set of icons 430 including thumbnail images or other graphical elements that a user may select to view individual test instances that correspond to error outputs of the machine learning system 108. The model development application 118 may further provide a second set of icons 432 including thumbnail images or other graphical elements that a user may select to view individual test instances (e.g., test instances views) that correspond to accurate outputs from the machine learning system 108.

The multi-branch display 422 may be generated in a number of ways and based on a number of factors. For example, model development application 118 may determine a depth of the multi-branch display 422 (e.g., a number of levels) based on a desired number of test instances represented by each node within the levels of the multi-branch display 422. In one or more embodiments, the model development application 118 generates the multi-branch display 422 based on feature combinations having a higher correlation to failure outputs such that the resulting multi-branch display 422 includes failures more heavily weighted to one side. In this way, the multi-branch display 422 provides a more useful performance view in which specific feature clusters may be identified that correspond more closely to failure outputs.

In one or more embodiments, the multi-branch display 422 is generated based on a machine learning model trained to generate the multi-branch display 422 in accordance with various constraints and parameters. In one or more embodiments, a user may indicate preferences or constraints such as a minimum number of instances each node should represent, a maximum number of combined features for an individual node, a maximum depth of the multi-branch display 422, or any other control for influencing the structure of the performance view(s).

Moving onto FIG. 4C, this figure illustrates an example instance performance view. Similar to the performance views discussed above, this performance view similarly is provided via a graphical user interface 402 of the client device 400. As further shown, the instance performance view may include a display of a multi-view indicator 404 and a feature space 408 including graphical elements (e.g., feature icons and associated importance indicators).

As further shown, the cluster performance view may include a displayed instance 436 including a face of an individual for which the machine learning system has classified incorrectly. The instance performance view may include facial indicators (e.g., interconnecting datapoints) corresponding to identified features or characteristics of the image used in determining a classification of male or female. In addition to the displayed instance 436, the instance performance view may include displayed instance data 438 including an indicator of the classification as well as an indication of whether the classification is accurate or not (e.g., whether the classification is consistent with corresponding ground truth data). The displayed instance data 438 may include a listing of identified feature (e.g., augmented features) from the label information (e.g., female, no smile, eye makeup). In one or more embodiments, the displayed instance data 438 may include one or more performance metrics, such as a confidence value corresponding to a confidence of the output determined by the machine learning system 108.

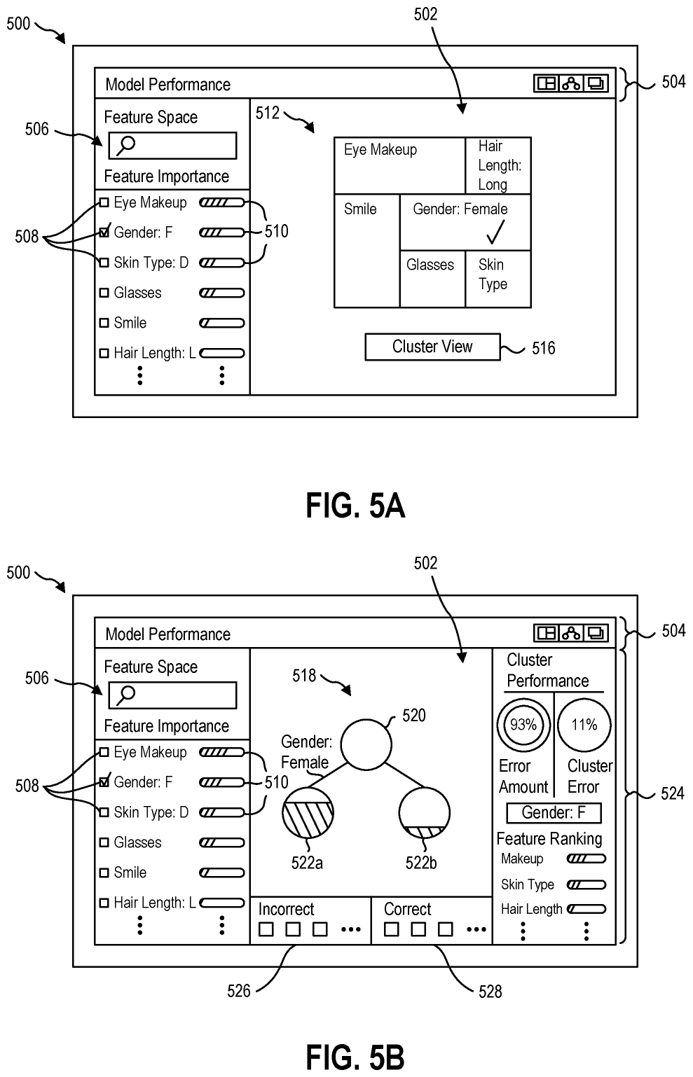

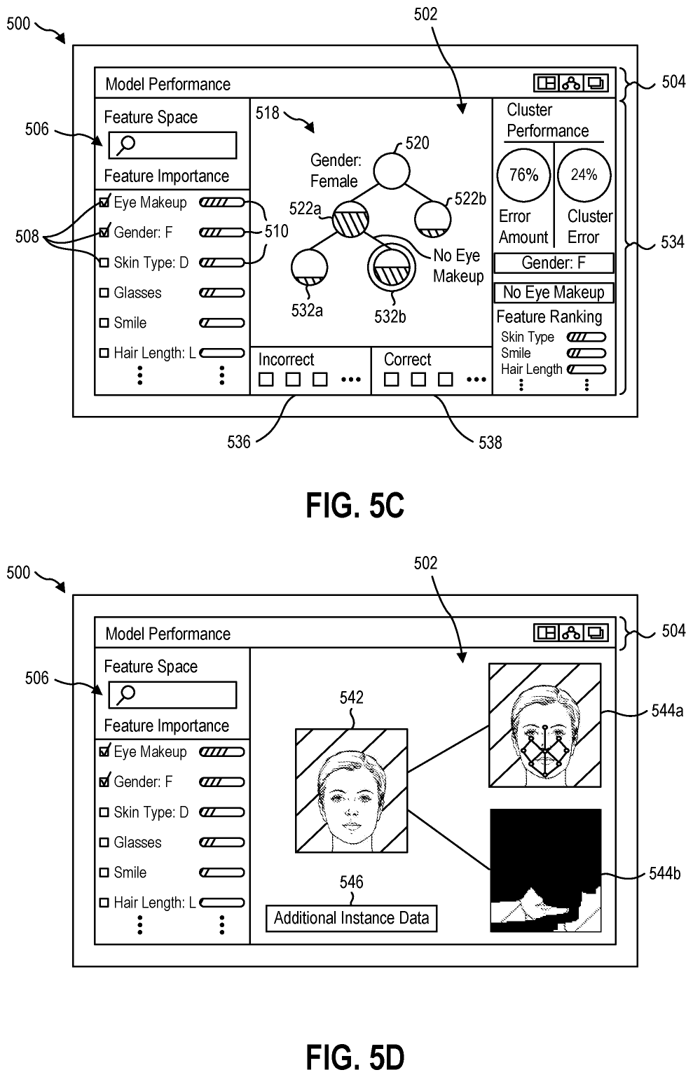

Moving onto FIGS. 5A-5D, these figures provide further example performance views illustrating different visualizations and interactive features in accordance with one or more embodiments. For example, FIG. 5A illustrates a global performance view for a test dataset based on performance information across multiple feature clusters of a test dataset. As shown in FIG. 5A, an example client device 500 may include a graphical user interface 502 within which the global performance view is displayed. The global performance view may include a multi-view indicator 504, a feature space 506, selectable feature icons 508, and importance indicators 510 in accordance with one or more embodiments described above.

As further shown, the global performance view may include a multi-cluster performance graphic 512 including cluster performance indicators 514 associated with identified combinations of features. As shown in FIG. 5A, the cluster performance indicators 514 may be associated with similar feature clusters as the examples discussed above in connection with FIG. 4A. In one or more embodiments, the performance indicators 514 may be selectable graphical elements. A user of the client device 500 may select a feature cluster by interacting with the displayed performance indicators 514. For example, as shown in FIG. 5A, a user may select the “Gender: Female” feature cluster by selecting the corresponding performance indicator from the multi-cluster performance graphic 512 (or alternatively from the list of feature icons 508).

Upon selecting a performance indicator associated with one or more feature clusters, the model development application 118 may provide a cluster view icon 516. The cluster view icon 516 may include a selectable graphical element that, when selected, causes the model development application 118 to transition between the global performance view and a cluster performance view including a visualization of performance of the machine learning system 108 for test instances from the selected feature cluster. For example, in response to detecting a selection of the cluster view icon 516, the model development application 118 may provide the cluster performance view shown in FIG. 5B.

As shown in FIG. 5B, the cluster performance view may include many similar features as the cluster performance view discussed above in connection with FIG. 4B. For example, the graphical user interface 502 may include a display of a feature space 506 including feature icons 508 and associated importance indicators 510. The cluster performance view may further include a multi-branch display 518 including a root node 520 at a first level of the multi-branch display 518 and multiple nodes 522a-b at a second level of the multi-branch display 518. The first node 522a of the second level may represent a subset of test instances associated with a female gender feature label while the second node 522b of the second level may represent a subset of test instances associated with a male gender feature label or otherwise not associated with the female gender feature label.

As shown in FIG. 5B, the nodes 522a-b may include a visualization of performance of the machine learning system 108 with respect to the displayed nodes 522a-b. For example, because the female gender label may have a higher correlation to failure outputs than other gender labels, the first node 522a may include shading representative of a number or percentage of error labels from the test dataset represented by the subset of test instances having the female feature label. Alternatively, because the second subset of instances not associated with the female gender feature label may be associated with a lower number or percentage of error labels, the second node 522b may include a smaller shaded portion than the first node 522a. The nodes 522a-b may include other types of visualizations (e.g., displayed numbers or text, node color, displayed sizes of the different nodes) of performance that illustrate various performance metrics.

As further shown in FIG. 5B, the cluster performance view may include additional performance data 524 displayed via the graphical user interface 502. For example, the additional performance data 524 may include an indication of a global performance (e.g., 93% accuracy), global error rate, or cluster error rate.

The additional performance data 524 may further include a ranking of features based on the current view of the cluster performance view. For example, in one or more embodiments, the feature ranking may include a similar ranking of features as the list of feature icons 508 and corresponding importance indicators 510. Alternatively, in one or more embodiments, the feature ranking may include an updated feature ranking that excludes one or more feature combinations represented in the multi-branch display 518. In one or more implementations, the feature ranking may include a recalibrated or updated list of feature combinations with different measures of importance than the original list of features (e.g., from the list of feature icons 508) based on analysis of error labels and corresponding feature combinations associated with those error labels limited to the subset of test instances from a selected node. Thus, where hair length may be less important when considering all feature combinations, hair length may become more important when considering only a subset of feature instances associated with the selected first node 522a.

Reordering the listing of feature combinations in this way provides a useful tool that enables an individual to more effectively navigate performance views. Moreover, by considering subsets of test instances rather than the dataset with each iterative display of the performance views, the model development application 118 may provide visual representations of performance information without performing analysis on the entire test dataset in response to each detected user interaction with the performance view. Thus, the performance views illustrated herein enable a user to effectively navigate through performance data while significantly reducing consumption of processing resources of a client device and/or server device(s).

Similar to one or more embodiments described herein, the cluster performance view may include groupings of test instances based on accurate or inaccurate classifications. For example, the graphical user interface 502 may include a first grouping of test instances 526 corresponding to incorrect outputs and a second grouping of test instances 528 corresponding to correct outputs. Each of the groupings of test instances 526-528 may include only those test instances from a selected node of the multi-branch display 518. For example, upon detecting a selection of the first node 522a from the second level of the multi-branch display 518, the groupings of test instances 526-528 may include groupings of test instances exclusive to the subset of test instances represented by the first node 522a.

Further in response to detecting a selection of the first node 522a and one or more additional features, the model development application 118 may modify the multi-branch display 518 to include one or more additional levels of the multi-branch display 518. For example, in response to detecting a selection of graphical element associated with an eye makeup feature cluster (e.g., from the feature icons 508 or other selectable graphical element), the additional performance data 524 may generate a third level of the multi-branch display 518 including a third node 532a representative of test instances that have been tagged with an “eye makeup” feature label and a fourth node 532b representative of test instances that have been tagged with a “no eye makeup” feature label (or that are not otherwise associate with the “eye makeup” feature label).

Each of the third node 532a and the fourth node 532b may represent respective subsets of test instances that makeup the larger subset of test instances represented by the first node 524a. For example, the third node 532a may represent test instances that include both a female gender feature label and an eye makeup feature label. Alternatively, the fourth node 532b may represent test instances that include the female gender feature label, but do not include the eye makeup feature label.

As shown in FIG. 5C, a greater concentration of failed outputs is associated with test instances from the test instances associated with the fourth node 532b associated with the female gender feature label, but not associated with the eye makeup feature label. The rate of errors may be indicated in similar fashion as the nodes from the first level of the multi-branch display 518. Moreover, similar to the example discussed above in connection with FIG. 5B, the graphical user interface 502 may include additional performance data 534 associated with the selected feature cluster showing performance data such as error rates, indications of selected feature labels, and a feature ranking. Furthermore, the performance cluster view may include different groupings of test instances 536-538 associated with incorrect and correct outputs of the machine learning system.

While FIG. 5C illustrates an example in which each level of the multi-branch display 518 includes only branches of the selected node, it will be appreciated that each of the nodes of the corresponding level may similarly expand to include nodes representative of subsets of test instances corresponding to selected features. For example, while FIG. 5C shows an example in which only the first node 524a of the second level of the multi-branch display 518 is expanded, the second node 524b may similarly expand to include a branch of multiple nodes on the third level of the multi-branch display 518 based on similar combinations of features (e.g., male with eye makeup, male with no eye makeup).

FIG. 5D illustrates an example instance performance view indicating performance of the machine learning system 108 with respect to an individual test instance. For example, in response to detecting a selection of a graphical element within one of the groupings of test instances 536-538 (or other displayed examples of grouped test instances), the model development application 118 may provide a displayed test instance 542 including any performance data associated with the displayed test instance 542.

As an illustrative example, the instance performance view may include a first performance display 544a including a displayed analysis of the content of the test instance. For example, where classifying the test instance or otherwise generating an output involves mapping facial features such as position or shapes of eyes, nose, mouth, or other facial characteristics, the model development application 118 may provide an illustration of that analysis via the first performance display 544a. As another example, where classifying the test instance or otherwise generating the output involves segmenting an image (e.g., identifying background and/or foreground pixels of a digital image), the model development application 118 may provide a second performance display 544b indicating results of a segmentation process. By viewing this performance information, a user of the client device 500 may identify that the machine learning system 108 (or specific component of the machine learning system) may have erroneously segmented the test instance to cause an output failure. The user may navigate through instance performance views in this way to identify scenarios in which the machine learning system 108 is failing and better understand how to diagnose and/or fix performance shortcoming of the machine learning system 108.

As shown in FIG. 5D, the instance performance view may further include an additional instance data icon 546 to view further information about the displayed test instance 542. For example, in response to detecting a selection of the additional instance data icon 546, the model development application 118 may provide additional performance data (e.g., similar to the additional performance data 438 shown in FIG. 4C). Further, the model development application 118 may provide side-by-side displays of similar test instances and corresponding performance information.

In each of the above examples, the model development application 116 may provide one or more selectable options for providing failure information to a training system 110 for use in further refining the machine learning system. For example, the model development application 116 may provide a selectable option within the feature space 506 or in conjunction with a node of a cluster performance view (or any performance view) that, when selected, provides an identification of feature labels and associated error rates for use in determining how to refine the machine learning system 108 (or individual components of the machine learning system 108). In particular, upon detecting a selection of an option to provide failure information to a training system 110, the client device 116 may provide failure information directly to a training system 110 or, alternatively, provide failure information to the model evaluation system 106 for use in identifying relevant information to provide to the training system 110.

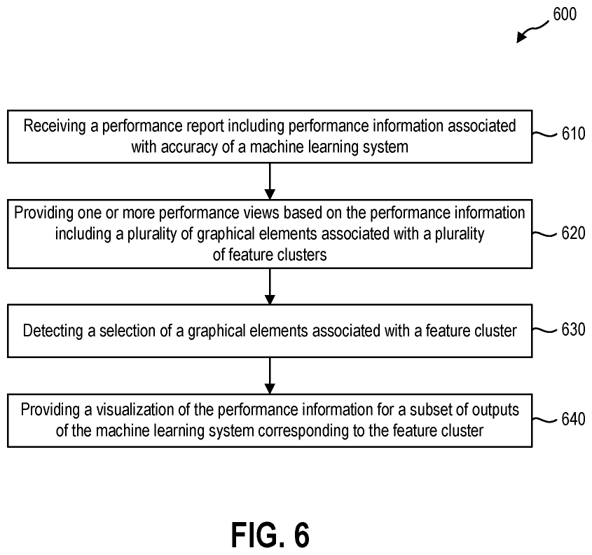

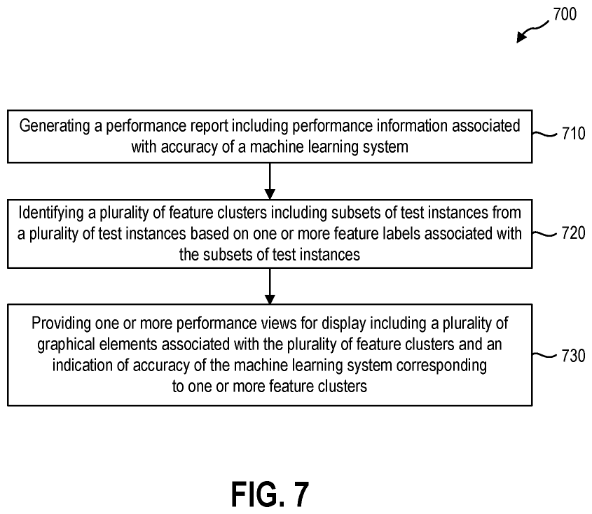

Turning now to FIGS. 6-7, these figures illustrate example flowcharts including series of acts for evaluating performance of a machine learning system and providing performance views including a visualization of the evaluated performance with respect to one or more feature clusters. While FIGS. 6-7 illustrates acts according to one or more embodiments, alternative embodiments may omit, add to, reorder, and/or modify any of the acts shown in FIGS. 6-7. The acts of FIGS. 6-7 can be performed as part of a method. Alternatively, a non-transitory computer-readable medium can include instructions that, when executed by one or more processors, cause a computing device (e.g., a server device and/or client device) to perform the acts of FIGS. 6-7. In still further embodiments, a system can perform the acts of FIGS. 6-7.

As shown in FIG. 6, a series of acts 600 may include an act 610 of receiving a performance report including performance information associated with accuracy of a machine learning system. In one or more embodiments, the act 610 includes receiving, at a client device, a performance report including performance information for a machine learning system. The performance information may include a plurality of outputs of the machine learning system for a plurality of test instances. The performance information may further include accuracy data of the plurality of outputs, wherein the accuracy data includes identified errors between outputs from the plurality of outputs and associated ground truth data corresponding to the plurality of test instances. The performance information may further include feature data associated with the plurality of test instances, the feature data comprising a plurality of feature labels associated with characteristics the plurality of test instances, evidential information provided by the machine learning system, and contextual information from the plurality of test instances.

As further shown, the series of acts 600 may include an act 620 of providing one or more performance views based on the performance information including a plurality of graphical elements associated with a plurality of feature clusters. For example, in one or more embodiments, the act 620 may include providing, via a graphical user interface, one or more performance views based on the performance information, the one or more performance views including a plurality of graphical elements associated with a plurality of feature clusters where the plurality of feature clusters include subsets of test instances from the plurality of test instances based on associated feature labels and where the one or performance views includes an indication of the accuracy data corresponding to at least one feature cluster from the plurality of feature clusters.

The series of acts 600 may additionally include an act 630 of detecting a selection of a graphical element associated with a feature cluster. For example, the act 630 may include detecting a selection of a graphical element from the plurality of graphical elements associated with a combination of one or more feature labels. The graphical elements may include a list of selectable features corresponding to the plurality of feature clusters where the selectable features are ranked within the list based on measures of correlation between the plurality of feature clusters and identified errors from the accuracy data.

The series of acts 600 may further include an act 640 of providing a visualization of the performance information for a subset of outputs of the machine learning system corresponding to the feature cluster. For example, in one or more embodiments, the act 640 may include providing a visualization of the accuracy data associated with a subset of outputs from the plurality of outputs corresponding to a subset of test instances corresponding to the combination of one or more feature labels.

In one or more embodiments, providing the one or more performance views includes providing a global performance view for the plurality of feature clusters. The global performance view may include a visual representation of the accuracy data with respect to multiple feature clusters of the plurality of feature clusters where the plurality of graphical elements includes selectable portions of the global performance view associated with the multiple feature clusters.

The series of acts 600 may further include detecting a selection of a graphical element corresponding to a first feature cluster from the plurality of feature clusters. In one or more embodiments, providing the one or more performance views includes providing a cluster performance view for the first feature cluster where the cluster performance view includes a visualization of the accuracy data for a first subset of outputs from the plurality of outputs associated with the first feature cluster.

The cluster performance view may include a multi-branch visualization of the accuracy data for the plurality of outputs. The multi-branch visualization may include a first branch including an indication of the accuracy data associated with the first subset of outputs from the plurality of outputs associated with the first feature cluster and a second branch including an indication of the accuracy data associated with a second subset of outputs from the plurality of outputs not associated with the first feature cluster. The series of acts 600 may further include detecting a selection of the first branch, detecting a selection of an additional graphical element corresponding to a second feature cluster from the plurality of feature clusters, and providing a third branch including an indication of the accuracy data associated with a third subset of outputs associated with a combination of feature labels shared by the first cluster and the second feature cluster. The multi-branch visualization of the accuracy data for the plurality of outputs may include a root node representative of the plurality of outputs for the plurality of test instances, a first level including a first node representative of the first subset of outputs and a second node representative of the second subset of outputs, and a second level including a third node representative of the third subset of outputs.

In one or more embodiments, providing the one or more performance views further includes providing an instance view associated with a selected feature cluster. The instance view may include a display of a test instance, a display of an output from the machine learning system for the test instance, and a display of at least a portion of the ground truth data for the test instance.

The series of acts 600 may further include providing, via the graphical user interface of the client device, a selectable option to provide failure information to a training system. The failure information may include an indication of one or more feature labels from the plurality of feature labels associated with a threshold rate of identified errors from the accuracy data. The series of acts 600 may also include providing the failure information to the training system including instructions for refining the machine learning system based on selectively identified training data associated with the one or more feature labels.

FIG. 7 illustrates a series of acts 700 including an act 710 of generating a performance report including performance information associated with accuracy of a machine learning system. For example, the act 710 may include generating a performance report including performance information for a machine learning system. The performance information may include a plurality of outputs of the machine learning system for a plurality of test instances. The performance information may further include accuracy data of the plurality of outputs including identified errors between outputs from the plurality of outputs and associated ground truth data with respect to the plurality of test instances. The performance information may also include feature data associated with the plurality of test instances, the feature data comprising a plurality of feature labels associated with characteristics of the plurality of test instances, evidential information provided by the machine learning system, and contextual information from the plurality of test instances.

As further shown, the series of acts 700 may include an act 720 of identifying a plurality of feature clusters including subsets of test instances from a plurality of test instances based on one or more feature labels associated with the subset of test instances. For example, the act 720 may include identifying a plurality of feature clusters comprising subsets of test instances from the plurality of test instances based on one or more feature labels associated with the subsets of test instances.

The series of acts 700 may also include an act 730 of providing one or more performance views for display including a plurality of graphical elements associated with the plurality of feature clusters and an indication of accuracy of the machine learning system corresponding to the one or more feature clusters. For example, the act 730 may include providing, for display via a graphical user interface of a client device, one or more performance views based on the performance information, the one or more performance views including a plurality of graphical elements associated with the plurality of feature clusters and an indication of the accuracy data corresponding to at least one feature cluster from the plurality of feature clusters.

The series of acts 700 may further include detecting a selection of a graphical element from the plurality of graphical elements associated with a feature cluster from the plurality of feature clusters. The series of acts 700 may also include providing a visualization of the accuracy data associated with a subset of outputs from the plurality of outputs corresponding to the feature cluster. In one or more embodiments, the series of acts 700 includes detecting a selection of a first graphical element corresponding to a first feature cluster from the plurality of feature clusters.

Further, providing the one or more performance views may include providing a cluster performance view for the first feature cluster including a visualization of the accuracy data for a first subset of outputs from the plurality of outputs associated with the first feature cluster. In one or more embodiments, providing the one or more performance views includes providing an instance view associated with the first feature cluster, wherein the instance view comprises a display of a test instance from the first feature cluster and associated accuracy data for the test instance.

In one or more embodiments, the series of acts 700 may include receiving an indication of one or more feature labels associated with a threshold rate of identified errors from the accuracy data. Moreover, the series of acts 700 may include causing a training system to refine the machine learning system based on a plurality of training instances associated with the one or more feature labels.

FIG. 8 illustrates certain components that may be included within a computer system 800. One or more computer systems 800 may be used to implement the various devices, components, and systems described herein.

The computer system 800 includes a processor 801. The processor 801 may be a general-purpose single or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 801 may be referred to as a central processing unit (CPU). Although just a single processor 801 is shown in the computer system 800 of FIG. 8, in an alternative configuration, a combination of processors (e.g., an ARM and DSP) could be used.

The computer system 800 also includes memory 803 in electronic communication with the processor 801. The memory 803 may be any electronic component capable of storing electronic information. For example, the memory 803 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 805 and data 807 may be stored in the memory 803. The instructions 805 may be executable by the processor 801 to implement some or all of the functionality disclosed herein. Executing the instructions 805 may involve the use of the data 807 that is stored in the memory 803. Any of the various examples of modules and components described herein may be implemented, partially or wholly, as instructions 805 stored in memory 803 and executed by the processor 801. Any of the various examples of data described herein may be among the data 807 that is stored in memory 803 and used during execution of the instructions 805 by the processor 801.

A computer system 800 may also include one or more communication interfaces 809 for communicating with other electronic devices. The communication interface(s) 809 may be based on wired communication technology, wireless communication technology, or both. Some examples of communication interfaces 809 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 800 may also include one or more input devices 811 and one or more output devices 813. Some examples of input devices 811 include a keyboard, mouse, microphone, remote control device, button, joystick, trackball, touchpad, and lightpen. Some examples of output devices 813 include a speaker and a printer. One specific type of output device that is typically included in a computer system 800 is a display device 815. Display devices 815 used with embodiments disclosed herein may utilize any suitable image projection technology, such as liquid crystal display (LCD), light-emitting diode (LED), gas plasma, electroluminescence, or the like. A display controller 817 may also be provided, for converting data 807 stored in the memory 803 into text, graphics, and/or moving images (as appropriate) shown on the display device 815.

The various components of the computer system 800 may be coupled together by one or more buses, which may include a power bus, a control signal bus, a status signal bus, a data bus, etc. For the sake of clarity, the various buses are illustrated in FIG. 8 as a bus system 819.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various embodiments.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element or feature described in relation to an embodiment herein may be combinable with any element or feature of any other embodiment described herein, where compatible.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method, comprising:
receiving, at a client device, a performance report including performance information for a machine learning system, wherein the performance information comprises:
a plurality of outputs of the machine learning system for a plurality of test instances;
accuracy data of the plurality of outputs, wherein the accuracy data includes identified errors between outputs from the plurality of outputs and associated ground truth data corresponding to the plurality of test instances;
feature data associated with the plurality of test instances, the feature data comprising a plurality of feature labels associated with characteristics the plurality of test instances, evidential information provided by the machine learning system, and contextual information from the plurality of test instances; and
providing, via a graphical user interface, one or more performance views based on the performance information, the one or more performance views including a plurality of graphical elements associated with a plurality of feature clusters, wherein the plurality of feature clusters include subsets of test instances from the plurality of test instances based on associated feature labels, and wherein the one or performance views includes an indication of the accuracy data corresponding to at least one feature cluster from the plurality of feature clusters.

2. The method of claim 1, further comprising:
detecting a selection of a graphical element from the plurality of graphical elements associated with a combination of one or more feature labels; and
providing a visualization of the accuracy data associated with a subset of outputs from the plurality of outputs corresponding to a subset of test instances corresponding to the combination of one or more feature labels.

3. The method of claim 1, wherein the plurality of graphical elements comprises a list of selectable features corresponding to the plurality of feature clusters, wherein the selectable features are ranked within the list based on measures of correlation between the plurality of feature clusters and identified errors from the accuracy data.

4. The method of claim 1, wherein providing the one or more performance views comprises providing a global performance view for the plurality of feature clusters, the global performance view including a visual representation of the accuracy data with respect to multiple feature clusters of the plurality of feature clusters, and wherein the plurality of graphical elements includes selectable portions of the global performance view associated with the multiple feature clusters.

5. The method of claim 1, further comprising:
detecting a selection of a graphical element corresponding to a first feature cluster from the plurality of feature clusters; and
wherein providing the one or more performance views comprises providing a cluster performance view for the first feature cluster, the cluster performance view comprising a visualization of the accuracy data for a first subset of outputs from the plurality of outputs associated with the first feature cluster.

6. The method of claim 5, wherein the cluster performance view comprises a multi-branch visualization of the accuracy data for the plurality of outputs, wherein the multi-branch visualization comprises:
a first branch including an indication of the accuracy data associated with the first subset of outputs from the plurality of outputs associated with the first feature cluster; and
a second branch including an indication of the accuracy data associated with a second subset of outputs from the plurality of outputs not associated with the first feature cluster.

7. The method of claim 6, further comprising:
detecting a selection of the first branch;
detecting a selection of an additional graphical element corresponding to a second feature cluster from the plurality of feature clusters; and
providing a third branch including an indication of the accuracy data associated with a third subset of outputs associated with a combination of feature labels shared by the first cluster and the second feature cluster.

8. The method of claim 7, wherein the multi-branch visualization of the accuracy data for the plurality of outputs comprises:
a root node representative of the plurality of outputs for the plurality of test instances;
a first level including a first node representative of the first subset of outputs and a second node representative of the second subset of outputs; and
a second level including a third node representative of the third subset of outputs.

9. The method of claim 1, wherein providing the one or more performance views further comprises providing an instance view associated with a selected feature cluster, wherein the instance view comprises a display of a test instance, a display of an output from the machine learning system for the test instance, and a display of at least a portion of the ground truth data for the test instance.

10. The method of claim 1, further comprising:
providing, via the graphical user interface of the client device, a selectable option to provide failure information to a training system, the failure information comprising an indication of one or more feature labels from the plurality of feature labels associated with a threshold rate of identified errors from the accuracy data; and
providing the failure information to the training system including instructions for refining the machine learning system based on selectively identified training data associated with the one or more feature labels.

11. A system, comprising:
one or more processors;
memory in electronic communication with the one or more processors; and
instructions stored in the memory, the instructions being executable by the one or more processors to cause a server device to:
generate a performance report including performance information for a machine learning system, wherein the performance information comprises:
a plurality of outputs of the machine learning system for a plurality of test instances;
accuracy data of the plurality of outputs including identified errors between outputs from the plurality of outputs and associated ground truth data with respect to the plurality of test instances; and
feature data associated with the plurality of test instances, the feature data comprising a plurality of feature labels associated with characteristics of the plurality of test instances, evidential information provided by the machine learning system, and contextual information from the plurality of test instances;
identify a plurality of feature clusters comprising subsets of test instances from the plurality of test instances based on one or more feature labels associated with the subsets of test instances;
provide, for display via a graphical user interface of a client device, one or more performance views based on the performance information, the one or more performance views including a plurality of graphical elements associated with the plurality of feature clusters and an indication of the accuracy data corresponding to at least one feature cluster from the plurality of feature clusters.

12. The system of claim 11, further comprising instructions being executable by the one or more processors to cause the server device to:
detect a selection of a graphical element from the plurality of graphical elements associated with a feature cluster from the plurality of feature clusters; and
provide a visualization of the accuracy data associated with a subset of outputs from the plurality of outputs corresponding to the feature cluster.

13. The system of claim 11, further comprising instructions being executable by the one or more processors to cause the server device to:
detect a selection of a first graphical element corresponding to a first feature cluster from the plurality of feature clusters;
wherein providing the one or more performance views comprises providing a cluster performance view for the first feature cluster comprising a visualization of the accuracy data for a first subset of outputs from the plurality of outputs associated with the first feature cluster.

14. The system of claim 13, wherein providing the one or more performance views further comprises providing an instance view associated with the first feature cluster, wherein the instance view comprises a display of a test instance from the first feature cluster and associated accuracy data for the test instance.

15. The system of claim 11, further comprising instructions being executable by the one or more processors to cause the server device to:
receive an indication of one or more feature labels associated with a threshold rate of identified errors from the accuracy data; and
cause a training system to refine the machine learning system based on a plurality of training instances associated with the one or more feature labels.

16. A non-transitory computer readable storage medium storing instructions thereon that, when executed by one or more processors, causes a client device to:
receive, at a client device, a performance report including performance information for a machine learning system, wherein the performance information comprises:
a plurality of outputs of the machine learning system for a plurality of test instances;
accuracy data of the plurality of outputs, wherein the accuracy data includes identified errors between outputs from the plurality of outputs and associated ground truth data corresponding to the plurality of test instances;
feature data associated with the plurality of test instances, the feature data comprising a plurality of feature labels associated with characteristics the plurality of test instances, evidential information provided by the machine learning system, and contextual information from the plurality of test instances; and
provide, via a graphical user interface of the client device, one or more performance views based on the performance information, the one or more performance views including a plurality of graphical elements associated with a plurality of feature clusters, wherein the plurality of feature clusters include subsets of test instances from the plurality of test instances based on associated feature labels, and wherein the one or performance views includes an indication of the accuracy data corresponding to at least one feature cluster from the plurality of feature clusters.

17. The non-transitory computer readable storage medium of claim 16, further comprising instructions that, when executed by the one or more processors, causes the client device to:
detect a selection of a graphical element from the plurality of graphical elements associated with a combination of one or more feature labels; and
provide a visualization of the accuracy data associated with a subset of outputs from the plurality of outputs corresponding to a first subset of test instances corresponding to the combination of one or more feature labels.

18. The non-transitory computer readable storage medium of claim 16, further comprising instructions that, when executed by the one or more processors, causes the client device to:
detect a selection of a graphical element corresponding to a first feature cluster from the plurality of feature clusters; and
wherein providing the one or more performance views comprises providing a cluster performance view for the first feature cluster, the cluster performance view comprising a visualization of the accuracy data for a subset of outputs from the plurality of outputs associated with the first feature cluster.

19. The non-transitory computer readable storage medium of claim 16, wherein providing the one or more performance views further comprises providing an instance view associated with a selected feature cluster, wherein the instance view comprises a display of a test instance, a display of an output from the machine learning system for the test instance, and a display of at least a portion of the ground truth data for the test instance.

20. The non-transitory computer readable storage medium of claim 16, further comprising instructions that, when executed by the one or more processors, causes the client device to:
providing, via the graphical user interface of the client device, a selectable option to provide failure information to a training system, the failure information comprising an indication of one or more feature labels from the plurality of feature labels associated with a threshold rate of identified errors from the accuracy data; and
providing the failure information to the training system including instructions for refining the machine learning system based on selectively identified training data associated with the one or more feature labels.
